(19) United States
(12) Patent Application Publication
(10) Pub. No.: US 2023/0146614 A1
(43) Pub. Date: May 11, 2023

(54) MATERIAL TESTING MACHINE

(71) Applicant: Shimadzu Corporation, Kyoto (JP)

(72) Inventor: Tohru MATSUURA, Kyoto (JP)

(73) Assignee: Shimadzu Corporation, Kyoto (JP)

(21) Appl. No.: 17/889,387

(22) Filed: Aug. 16, 2022

(30) Foreign Application Priority Data
Sep. 17, 2021 (JP) 2021-152405

(51) Int. Cl. G01N 3/10

(52) U.S. Cl. CPC G01N 3/10; G01N 2203/0003; G01N 2203/0017; G01N 2203/0048

(57) ABSTRACT

Provided is a tensile testing machine that includes a testing machine main body having a hydraulic actuator, the tensile testing machine including an estimation unit that estimates a response characteristic of the tensile testing machine, in which the estimation unit obtains the response characteristic of the testing machine main body in a state in which a first set value used for a tensile test performed by the tensile testing machine is set as a control parameter specifying operation of the hydraulic actuator, and estimates, based on the obtained response characteristic of the testing machine main body, the response characteristic of the tensile testing machine in a state in which a second set value different from the first set value is set as the control parameter.

### CROSS REFERENCE

The present application claims priority under 35 U.S.C.§ 119 to Japanese Patent Application No. 2021-152405 filed on Sep. 17, 2021. The content of the application is incorporated herein by reference in its entirety.

### BACKGROUND

### Technical Field

The present disclosure relates to a material testing machine.

### Related Art

A control parameter that specifies operation of an actuator included in a testing machine is known. For example, JP 2009-002900 A discloses a motor that causes a crosshead as an actuator included in a testing machine to move up and down, and discloses a gain of PID control that controls driving of the motor as a control parameter that specifies operation of the motor.

### SUMMARY

However, in the testing machine described in JP 2009-002900 A, in a case where an operator adjusts a value of the control parameter, a test for obtaining a response characteristic of the material testing machine is performed every time the value of the control parameter is changed, and it is confirmed whether or not the value of the control parameter after the change is appropriate.

According to an embodiment of the present disclosure, there is provided a material testing machine that includes a testing machine main body having an actuator, the material testing machine including an estimation unit that estimates a response characteristic of the material testing machine, in which the estimation unit obtains the response characteristic of the testing machine main body in a state in which a first set value used for a material test performed by the material testing machine is set as a control parameter specifying operation of the actuator, and estimates, based on the obtained response characteristic of the testing machine main body, the response characteristic of the material testing machine in a state in which a second set value different from the first set value is set as the control parameter.

### BRIEF DESCRIPTION OF DRAWINGS

FIG. 1 is a diagram illustrating an example of a configuration of a tensile testing machine according to the present embodiment;

FIG. 2 is a diagram illustrating an example of a configuration of a control device;

FIG. 3 is a diagram illustrating an example of a configuration of a feedback control unit;

FIG. 4 is a gain diagram illustrating an experiment result for confirming estimation accuracy of an estimation unit;

FIG. 5 is a diagram illustrating an example of a gain diagram displayed by a display control unit;

FIG. 6 is a diagram illustrating an example of a phase diagram displayed by a display control unit;

FIG. 7 is a diagram illustrating an example of a gain diagram displayed by a display control unit;

FIG. 8 is a diagram illustrating an example of a phase diagram displayed by a display control unit;

FIG. 9 is a diagram illustrating an example of a gain diagram displayed by a display control unit;

FIG. 10 is a diagram illustrating an example of a phase diagram displayed by a display control unit; and

FIG. 11 is a flowchart illustrating an example of processing of a control unit.

### DETAILED DESCRIPTION

An embodiment of the present disclosure is to provide a material testing machine capable of reducing labor of an operator in adjustment of a control parameter.

According to an embodiment of the present disclosure, it is possible to obtain the response characteristic of the material testing machine in a case where the value of the control parameter is changed, and thus the operator can adjust the control parameter without performing a test for obtaining the response characteristic of the material testing machine. Therefore, it is possible to reduce the labor of the operator in adjusting the control parameter.

Hereinafter, the embodiment of the present disclosure will be described with reference to the drawings.

### 1. CONFIGURATION OF TENSILE TESTING MACHINE

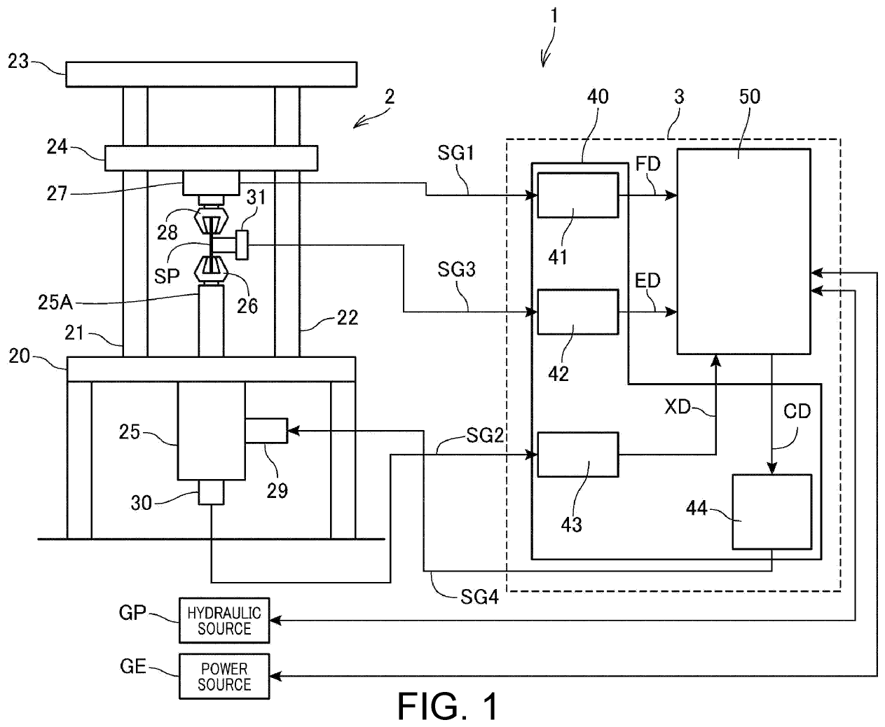

FIG. 1 is a diagram illustrating an example of a configuration of a tensile testing machine 1 according to the present embodiment.

The tensile testing machine 1 of the present embodiment applies a testing force to a specimen SP to perform a tensile test for measuring mechanical properties such as a tensile strength, a yield point, elongation, and a reduction area of the specimen SP. The testing force is a tensile force.

The tensile testing machine 1 includes a testing machine main body 2 that applies the testing force to the specimen SP, which is a material to be tested, to perform the tensile test, and a control unit 3 that controls tensile test operation performed by the testing machine main body 2.

The tensile testing machine 1 corresponds to an example of a “material testing machine”. The tensile test corresponds to an example of a “material test”.

As illustrated in FIG. 1, the testing machine main body 2 is configured so that a load frame is formed on a base 20, the load frame being formed by a pair of support columns 21 and 22, and a yoke 23, and a crosshead 24 is fixed to the support columns 21 and 22.

A hydraulic actuator 25 is disposed to the base 20, and a lower gripper 26 for gripping a lower end of the specimen SP is attached to a piston rod 25A of the hydraulic actuator 25. An upper gripper 28 for gripping an upper end of the specimen SP is attached to the crosshead 24 via a load cell 27.

The hydraulic actuator 25 corresponds to an example of an “actuator”.

A hydraulic direction and a hydraulic amount of the hydraulic actuator 25 are controlled by a servo valve 29, and the piston rod 25A extends and contracts. As a result, a distance between the upper gripper 28 and the lower gripper 26 is increased and decreased, and the testing force is applied to the specimen SP fixed between the upper gripper 28 and the lower gripper 26. A stroke of the hydraulic actuator 25, that is, displacement of the specimen SP is detected by a differential transformer 30 attached to the hydraulic actuator 25.

The load cell 27 is a sensor that measures the testing force, which is a tensile load applied to the specimen SP, and outputs a testing force measurement signal SG1 to the control unit 3.

The differential transformer 30 is a sensor that measures a displacement amount of the specimen SP and outputs a displacement measurement signal SG2 corresponding to the displacement amount to the control unit 3.

A displacement sensor 31 is disposed on the specimen SP. For example, a dumbbell-shaped test piece formed to be constricted in the central portion is used as the specimen SP. The displacement sensor 31 is a sensor that measures an elongation measurement value ED by measuring a distance between a pair of marked points of the specimen SP, and outputs an elongation measurement signal SG3 to the control unit 3. The pair of marked points are disposed at an upper portion and a lower portion of the constricted region of the specimen SP.

The testing machine main body 2 further includes a power source GE and a hydraulic source GP.

The power source GE supplies power to each unit of the testing machine main body 2. The power source GE supplies power to, for example, various motors and drives the motors. The power source GE supplies power to a hydraulic pump and a hydraulic control valve (which are not illustrated), and drives the hydraulic pump and the hydraulic control valve.

The power source GE is configured as, for example, a voltage source. The power source GE supplies power corresponding to each unit of the testing machine main body 2. For example, the power source GE supplies a voltage of 100 V to the hydraulic pump and the various motors, and supplies a voltage of 10 V to the control unit 3.

The hydraulic source GP supplies a hydraulic pressure to a hydraulic device constituting the testing machine main body 2. The hydraulic source GP supplies, for example, hydraulic pressure to the hydraulic actuator 25 and drives the hydraulic actuator 25. That is, the hydraulic actuator 25 is driven by the hydraulic pressure supplied from the hydraulic source GP, and the piston rod 25A is extended and contracted.

The hydraulic source GP includes a hydraulic pump and a hydraulic control valve (which are not illustrated), and generates hydraulic pressure by driving the hydraulic pump. Power is supplied from the power source GE to the hydraulic pump. The hydraulic control valve adjusts the hydraulic pressure output from the hydraulic source GP.

The control unit 3 includes a signal input and output device 40 and a control device 50.

The signal input and output device 40 configures an input and output interface circuit that transmits and receives a signal to and from the testing machine main body 2. The signal input and output device 40 according to the present embodiment includes a first sensor amplifier 41, a second sensor amplifier 42, a third sensor amplifier 43, and a servo amplifier 44.

The first sensor amplifier 41 is a device that amplifies the testing force measurement signal SG1 output from the load cell 27 to generate a testing force measurement value FD, and outputs the testing force measurement value FD to the control device 50. The testing force measurement value FD indicates the testing force applied to the specimen SP.

The second sensor amplifier 42 is a device that amplifies the elongation measurement signal SG3 output from the displacement sensor 31 to generate an elongation measurement value ED, and outputs the elongation measurement value ED to the control device 50. The elongation measurement value ED indicates the elongation of the specimen SP.

The third sensor amplifier 43 is a device that amplifies the displacement measurement signal SG2 output from the differential transformer 30 to generate a displacement measurement value XD, and outputs the generated displacement measurement value XD to the control device 50. The displacement measurement value XD indicates displacement X of the hydraulic actuator 25.

The servo amplifier 44 is a device that controls the servo valve 29 according to the control of the control device 50. The control device 50 generates a command value CD based on at least one of the testing force measurement value FD or the displacement measurement value XD, and outputs the generated command value CD to the servo amplifier 44. The servo amplifier 44 generates a command signal SG4 indicating the command value CD and outputs the generated command signal SG4 to the servo valve 29. The servo valve 29 controls the hydraulic direction and the hydraulic amount with respect to the hydraulic actuator 25 according to the command signal SG4 output from the servo amplifier 44.

### 2. CONFIGURATION OF CONTROL DEVICE

The control device 50 controls the operation of the testing machine main body 2 based on an operation from the user. The control device 50 causes the testing machine main body 2 to execute the tensile test.

In the present embodiment, the “user” includes an operator who adjusts a control parameter 543.

The control device 50 includes a computer including a storage device such as a hard disk drive (HDD) or a solid state drive (SSD), an interface circuit with each of the signal input and output device 40 and an operation panel 51, and various electronic circuits.

The control device 50 is not limited to the computer, and may be configured of one or more appropriate circuits such as an integrated circuit such as an IC chip or an LSI.

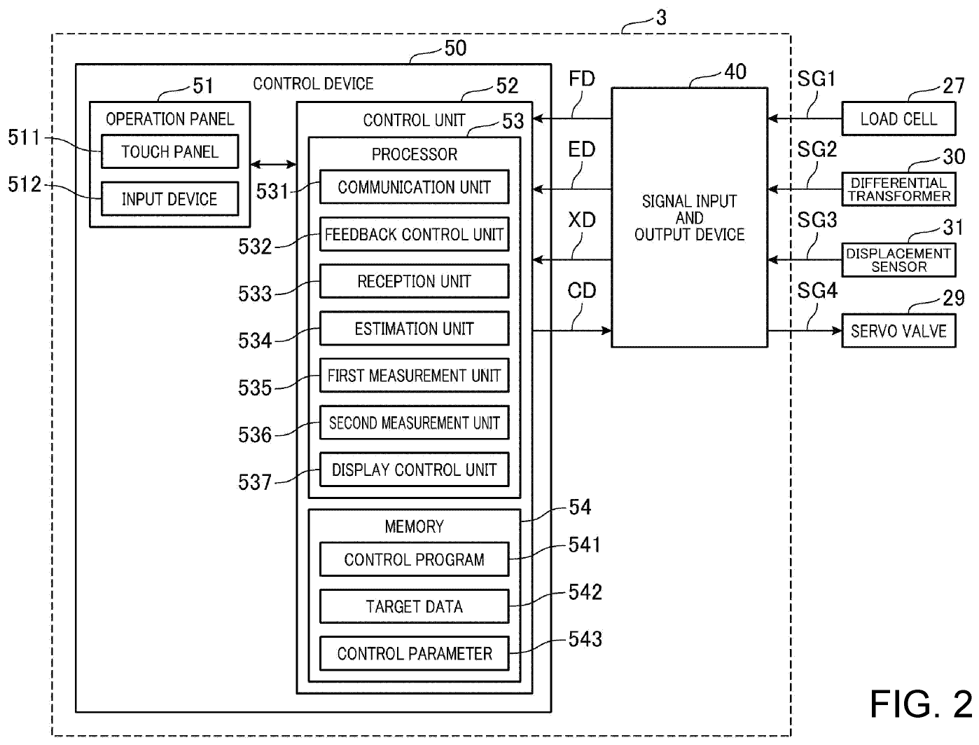

FIG. 2 is a diagram illustrating an example of a configuration of the control device 50.

The control device 50 includes the operation panel 51 and a control unit 52.

The operation panel 51 includes a touch panel 511 and an input device 512 other than the touch panel 511, such as a button or a numeric keypad.

The touch panel 511 includes a liquid crystal display (LCD), and displays various images on the LCD according to an instruction from the control unit 52. The touch panel 511 includes a touch sensor disposed along a display surface of the LCD. The touch sensor detects a touch with a user's fingertip or a pen, and transmits a detection signal to the control unit 52.

The control unit 52 includes, for example, a personal computer, and controls the operation of the control device 50. The control unit 52 includes a processor 53 and a memory 54.

The processor 53 includes a central processing unit (CPU), and a micro-processing unit (MPU).

The memory 54 includes a read only memory (ROM), and a random access memory (RAM). The memory 54 stores a control program 541, target data 542, and the control parameter 543.

The target data 542 is time-series data indicating a temporal change in a target value of a physical quantity in the material test. The target data 542 of the present embodiment is time-series data of the target value of the testing force in the tensile test.

The control parameter 543 is a parameter that specifies the operation of the hydraulic actuator 25. In the present embodiment, the operation of the hydraulic actuator 25 is controlled by two-degree-of-freedom PID control. Therefore, the control parameter 543 of the present embodiment includes a proportional gain P, a differential gain D, an integration gain I, a first coefficient b, and a second coefficient c.

The control unit 52 is not limited to the personal computer, and may be configured of one or more appropriate circuits such as an integrated circuit such as an IC chip or an LSI. The control unit 52 may be configured as, for example, a tablet terminal or a smartphone.

The control unit 52 may include programmed hardware such as a digital signal processor (DSP) and a field programmable gate array (FPGA). The control unit 52 may include a system-on-a-chip (SoC)-FPGA.

### 3. CONFIGURATION OF CONTROL UNIT

As illustrated in FIG. 2, the control unit 52 includes a communication unit 531, a feedback control unit 532, a reception unit 533, an estimation unit 534, a first measurement unit 535, a second measurement unit 536, and a display control unit 537.

Specifically, the processor 53 of the control unit 52 executes a control program 541 stored in the memory 54 to function as the communication unit 531, the feedback control unit 532, the reception unit 533, the estimation unit 534, the first measurement unit 535, the second measurement unit 536, and the display control unit 537.

The communication unit 531 controls communication with the signal input and output device 40.

For example, the communication unit 531 receives the testing force measurement value FD, the elongation measurement value ED, and the displacement measurement value XD from the signal input and output device 40. For example, the communication unit 531 transmits the command value CD to the signal input and output device 40.

[3-1. Configuration of Feedback Control Unit]

The feedback control unit 532 feedback-controls the hydraulic actuator 25 in the tensile test.

In the present embodiment, a case where the feedback control unit 532 performs position control on the testing force measurement signal SG1 output from the load cell 27 will be described. In this case, the feedback control unit 532 calculates the command value CD of the displacement measurement signal SG2 so that the testing force measurement value FD matches a testing force target value FE, and outputs the command signal SG4 indicating the command value CD to the servo valve 29.

The position control indicates that a detection value measured by the sensor or the like is controlled to match the target value.

In the present embodiment, a case where the position control is performed on the testing force measurement value FD will be described, but the feedback control unit 532 may perform the position control on the elongation measurement value ED. In this case, the feedback control unit 532 calculates the command value CD of the displacement measurement value XD so that the elongation measurement value ED measured by the displacement sensor 31 matches an elongation target value, and outputs the command signal SG4 indicating the command value CD to the servo valve 29.

The feedback control unit 532 may execute the position control on the displacement measurement value XD. In this case, the feedback control unit 532 calculates the command value CD of the displacement measurement value XD so that the displacement measurement value XD matches a displacement target value, and outputs the command signal SG4 indicating the command value CD to the servo valve 29.

The feedback control unit 532 may execute speed control on the testing force measurement value FD. In this case, the feedback control unit 532 calculates the command value CD of the displacement measurement value XD so that a testing force measurement value speed matches a target value of a testing force speed, and outputs the command signal SG4 indicating the command value CD to the servo valve 29. The testing force measurement value speed indicates a change amount per unit time of the testing force measurement value FD, and the target value of the testing force speed indicates a target value of the testing force measurement value speed.

The speed control indicates that a change amount per unit time of the detection value measured by the sensor or the like is controlled to match the target value.

The feedback control unit 532 may execute the speed control on the elongation measurement value ED. In this case, the feedback control unit 532 calculates the command value CD of the displacement measurement value XD so that an elongation measurement value speed matches a target value of an elongation speed, and outputs the command signal SG4 indicating the command value CD to the servo valve 29. The elongation measurement value speed indicates a change amount per unit time of the elongation measurement value ED, and the target value of the elongation speed indicates the target value of the elongation measurement value speed.

The feedback control unit 532 may execute the speed control on the displacement measurement value XD. In this case, the feedback control unit 532 calculates the command value CD of the displacement measurement value XD so that a displacement measurement value speed matches a target value of a displacement speed, and outputs the command signal SG4 indicating the command value CD to the servo valve 29. The displacement measurement value speed indicates a change amount per unit time of the displacement measurement value XD, and the target value of the displacement speed indicates the target value of the displacement measurement value speed.

For example, a dynamic strain meter, a pressure gauge, an accelerometer, and the like may be incorporated in the signal input and output device 40, and the feedback-control may be performed on other measurement values.

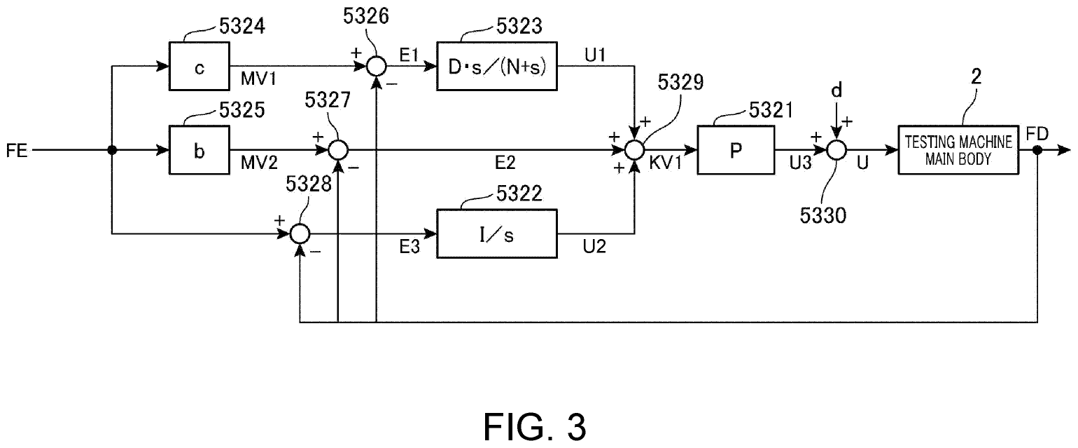

FIG. 3 is a diagram illustrating an example of a configuration of the feedback control unit 532.

In the present embodiment, two-degree-of-freedom proportional-integral-differential (PID) control is used for the feedback-control. The feedback control unit 532 includes a proportionator 5321, an integrator 5322, and a differentiator 5323. The feedback control unit 532 includes a first multiplier 5324, a second multiplier 5325, a first subtractor 5326, a second subtractor 5327, a third subtractor 5328, a first adder 5329, and a second adder 5330.

The first multiplier 5324 outputs, to the first subtractor 5326, a first multiplication value MV1 obtained by multiplying the testing force target value FE by the first coefficient b. The first subtractor 5326 outputs, to the differentiator 5323, a first deviation E1 obtained by subtracting the testing force measurement value FD from the first multiplication value MV1. The differentiator 5323 outputs a first operation amount U1 to the first adder 5329.

The second multiplier 5325 outputs, to the second subtractor 5327, a second multiplication value MV2 obtained by multiplying the testing force target value FE by the second coefficient c. The second subtractor 5327 outputs, to the first adder 5329, a second deviation E2 obtained by subtracting the testing force measurement value FD from the second multiplication value MV2.

The third subtractor 5328 outputs, to the integrator 5322, a third deviation E3 obtained by subtracting the testing force measurement value FD from the testing force target value FE. The integrator 5322 outputs a second operation amount U2 to the first adder 5329.

The first adder 5329 outputs, to the proportionator 5321, a first addition value KV1 obtained by adding the first operation amount U1, the second deviation E2, and the second operation amount U2. The proportionator 5321 outputs a third operation amount U3 to the second adder 5330. The second adder 5330 outputs, to the testing machine main body 2, an operation amount U obtained by adding external disturbance d to the third operation amount U3. The operation amount U input to the testing machine main body 2 indicates, for example, an opening and closing amount of the servo valve 29.

Returning to the description of FIG. 2, the reception unit 533 receives a second set value as a candidate for a set value to be set as the control parameter 543 in the adjustment of the control parameter 543 by the user. The second set value indicates a set value different from a first set value to be described later, and does not indicate a specific set value. The reception unit 533 can receive a plurality of candidates having different values by receiving a third set value different from the second set value. The reception unit 533 may receive a candidate from the user via the operation panel 51, or may receive a candidate determined by a functional unit that automatically determines the candidate. The third set value indicates a set value different from the second set value, and does not indicate a specific set value.

[3-2. Configuration of Estimation Unit]

In a case where the reception unit 533 receives the second set value, the estimation unit 534 estimates a response characteristic of the tensile testing machine 1 in a state in which the second set value is set as the control parameter 543. In other words, the estimation unit 534 estimates the response characteristic of the tensile testing machine 1 in a case where the second set value is set as the control parameter 543. The estimation unit 534 estimates, as the response characteristic of the tensile testing machine 1, a gain characteristic that is a characteristic of a gain to a frequency and a phase characteristic that is a characteristic of a phase to the frequency.

The estimation unit 534 estimates the response characteristic of the tensile testing machine 1 based on the following Equations (1) and (2). The response characteristic of the tensile testing machine 1 is a response characteristic of a system including the testing machine main body 2, the specimen SP attached to the testing machine main body 2, and the control unit 3.

$$[ Math . 1 ]$$

$$Gry ( s ) = \frac{P \cdot P ( s ) \cdot ( \frac{D \cdot c \cdot s}{\frac{s}{N} + 1} + \frac{I}{s} + b )}{P \cdot P ( s ) \cdot ( \frac{D \cdot s}{\frac{s}{N} + 1} + \frac{I}{s} + 1 ) + 1} \qquad ( 1 )$$

Where Gry(s) represents a transfer function of the tensile testing machine 1 in a case where a configuration of the feedback control unit 532 is the configuration of FIG. 3. In Equation (1), the external disturbance d is set to zero. P represents a proportional gain of the proportionator 5321. P(s) represents a response characteristic of the testing machine main body 2. D represents a differential gain of the differentiator 5323. I represents an integration gain of the integrator 5322. b represents a first coefficient. c represents a second coefficient. s represents a variable in Laplace transform. N represents a filter coefficient.

$$[ Math . 2 ]$$

$$P ( s ) = \frac{Gry \cdot {s}^{2} + Gry \cdot N \cdot s}{\begin{matrix}( D \cdot N \cdot P \cdot c + P \cdot b + ( - D \cdot Gry \cdot N - Gry ) \cdot P ) \cdot {s}^{2} + \\ ( N \cdot P \cdot b + ( ( 1 - Gry ) \cdot I - Gry \cdot N ) \cdot P ) \cdot s + ( 1 - Gry ) \cdot I \cdot N \cdot P\end{matrix}} \qquad ( 2 )$$

Equation (2) is an equation obtained by solving Equation (1) for P(s).

The estimation by the estimation unit 534 will be described in detail.

Here, Gry(s) obtained by the estimation unit 534 is denoted as Gry_predict(s).

The estimation unit 534 obtains P(s) in a state in which the first set value is set as the control parameter 543. P(s) is denoted as P_actual(s). The first set value is a set value of the control parameter 543 used in the tensile test performed by the tensile testing machine 1, and is a set value set as the control parameter 543 when the estimation unit 534 performs estimation. The first set value includes a value of the proportional gain P, a value of the integration gain I, a value of the differential gain D, a value of the first coefficient b, and a value of the second coefficient c. Here, the value of the proportional gain P included in the first set value is denoted as P_actual. The value of the differential gain D included in the first set value is denoted as D actual. The value of the integration gain I included in the first set value is denoted as I_actual. The value of the first coefficient b included in the first set value is denoted as b_actual. The value of the second coefficient c included in the first set value is denoted as c_actual. The first set value is included in the control parameter 543 stored in the memory 54.

The estimation unit 534 obtains P_actual(s) by substituting P_actual for P in Equation (2), D actual for D in Equation (2), I_actual for I in Equation (2), b_actual for b in Equation (2), c_actual for c in Equation (2), and Gry_actual(s) for Gry(s) in Equation (2).

Gry_actual(s) is the actually measured transfer function of the tensile testing machine 1. Gry_actual(s) is obtained, for example, by system identification in an autoregressive moving average model (ARMA model). Gry_actual(s) is obtained by the estimation unit 534. Gry_actual(s) may be obtained in advance before the estimation unit 534 estimates the response characteristic of the tensile testing machine 1, or may be obtained when the estimation unit 534 estimates the response characteristic of the tensile testing machine 1.

In a case where Gry_actual(s) is obtained by the system identification in the ARMA model, the estimation unit 534 obtains Gry_actual(s) based on the following Equations (3) and (4).

[Math. 3]

yₜ=φ₁yₜ₋₁+φ₂yₜ₋_{₂}+ . . . +φₚyₜ₋_{ₚ}+uₜ−θ₁yₜ_{_{−1}}−θ₂uₜ₋₂− . . . −θ_{q}yₜ_{_{−q}} (3)

Where y is a response value, and is the testing force measurement value FD in the present embodiment. A subscript “t-p” of y indicates a sampling period. u is a target value and is the testing force target value FE in the present embodiment. A subscript “t-q” of u indicates a sampling period. φ₁, φ₂, . . . φₚ, θ₁, θ₂, . . . θ_{q} are parameters.

$$[ Math . 4 ]$$

$$y = \frac{1 - {θ}_{1} {z}^{- 1} - {θ}_{2} {z}^{- 2} - … - {θ}_{q} {z}^{- q}}{1 - {φ}_{1} {z}^{- 1} - {φ}_{2} {z}^{- 2} - … - {φ}_{p} {z}^{- p}} u = G ( z ) \cdot u \qquad ( 4 )$$

Equation (4) is an equation obtained by modifying Equation (3) in a case where yₜ₋ₚ=yₜ·z^{-p} and u_{t-q}=uₜ·z^{-q}. Here, z is a variable of Z transform.

The estimation unit 534 obtains φ₁, φ₂, . . . φₚ, θ₁, θ₂, . . . θ_{q} based on an algorithm in the ARMA model by using data of y that is the response value and data of u that is a target value. The estimation unit 534 substitutes the obtained φ₁, φ₂, . . . φₚ, θ₁, θ₂, . . . θ_{q} into Equation (4) to obtain G(z) of Equation (4). In a case where the estimation unit 534 obtains Gry_actual(s) when estimating the response characteristic of the tensile testing machine 1, the data of y which is the response value and the data of u which is the target value are stored in the memory 54.

The variable z in the Z transform corresponds to e^{sT}. Here, e is a Napier's constant, s is a variable in Laplace transform, and T is a sampling period in Z transform. The estimation unit 534 sets z=e^{sT}, and transforms the obtained G(z) into G(s) of Laplace transform. The estimation unit 534 obtains the transformed G (s) as Gry_actual(s).

The estimation unit 534 obtains Gry_predict(s) by substituting the obtained P_actual(s) and the second set value received by the reception unit 533 into Equation (1). The second set value includes a value of the proportional gain P, a value of the integration gain I, a value of the differential gain D, a value of the first coefficient b, and a value of the second coefficient c. Here, the value of the proportional gain P included in the second set value is denoted as P candidate. The value of the differential gain D included in the second set value is denoted as D candidate. The value of the integration gain I included in the second set value is denoted as I_candidate. The value of the first coefficient b included in the second set value is denoted as b_candidate. The value of the second coefficient c included in the second set value is denoted as c_candidate.

The estimation unit 534 obtains Gry_predict(s) by substituting the obtained P_actual(s) for P(s) in Equation (1), P candidate for P in Equation (1), D candidate for D in Equation (1), I_candidate for I in Equation (1), b_candidate for b in Equation (1), and c_candidate for c in Equation (1).

The estimation unit 534 estimates the gain characteristic and the phase characteristic as the response characteristic of the tensile testing machine 1 based on the obtained Gry_predict(s).

In a case where the reception unit 533 receives the third set value in addition to the second set value, the estimation unit 534 estimates a first response characteristic that is the response characteristic of the tensile testing machine 1 in a case where the second set value is set as the control parameter 543 and a second response characteristic that is the response characteristic of the tensile testing machine 1 in a case where the third set value is set as the control parameter 543. The estimation unit 534 estimates the second response characteristic similarly to the estimation for the second set value described above.

[3-3. Experiment Result for Estimation Accuracy]

An experiment result for confirming the estimation accuracy of the estimation unit 534 will be described.

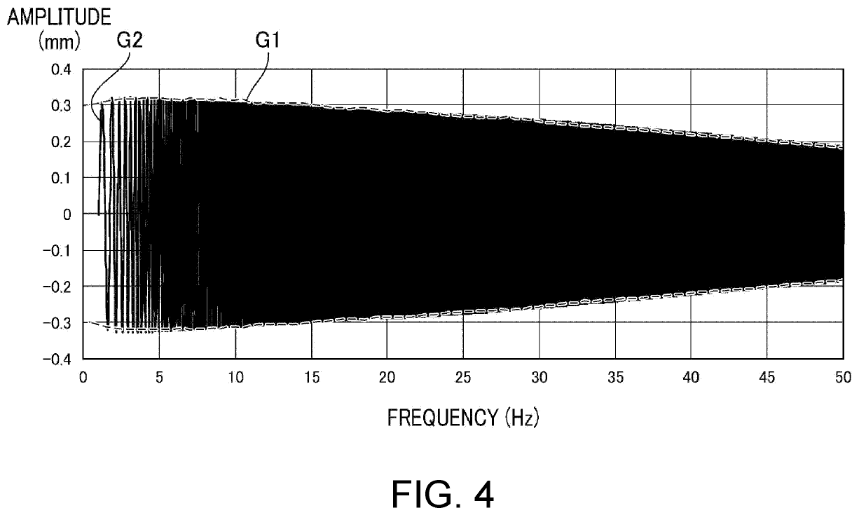

FIG. 4 is a gain diagram illustrating the experiment result for confirming the estimation accuracy of the estimation unit 534.

A graph G1 in FIG. 4 indicates gain characteristic estimated by the estimation unit 534. A graph G2 in FIG. 4 indicates actually measured gain characteristic. The gain characteristic indicated by the graph G2 is a gain characteristic measured in a state in which the second set value used for estimating the gain characteristic indicated by the graph G1 is set as the control parameter 543. The gain characteristic indicated by the graph G2 is a characteristic obtained by an experiment in a case where the frequency is linearly increased from 1 Hz to 50 Hz for 49 seconds with an amplitude range set to ±0.3 mm.

An amplitude value indicated by the graph G1 and an amplitude value indicated by the graph G2 substantially coincide with each other, and it is found that the estimation unit 534 can accurately estimate the response characteristic of the tensile testing machine 1.

Returning to FIG. 2, the first measurement unit 535 measures the response characteristic of the tensile testing machine 1 in a state in which the first set value is set as the control parameter 543. The first measurement unit 535 inputs a random wave or a sweep wave into the two-degree-of-freedom PID control illustrated in FIG. 3 in a state in which the first set value is set as the control parameter 543. According to this, the first measurement unit 535 measures the response characteristic of the tensile testing machine 1 in a state in which the first set value is set as the control parameter 543. The first measurement unit 535 measures the gain characteristic and the phase characteristic as the response characteristic of the tensile testing machine 1.

The second measurement unit 536 measures the response characteristic of the tensile testing machine 1 in a state in which the second set value received by the reception unit 533 is set as the control parameter 543. The second measurement unit 536 inputs a random wave or a sweep wave into the two-degree-of-freedom PID control illustrated in FIG. 3 in a state in which the second set value received by the reception unit 533 is set as the control parameter 543. According to this, the second measurement unit 536 measures the response characteristic of the tensile testing machine 1 in a state in which the second set value is set as the control parameter 543. The second measurement unit 536 measures the gain characteristic and the phase characteristic as the response characteristic of the tensile testing machine 1.

The display control unit 537 displays the response characteristic of the tensile testing machine 1, which is estimated by the estimation unit 534, on the touch panel 511. The display control unit 537 displays the response characteristic of the tensile testing machine 1, which is estimated by the estimation unit 534, and the response characteristic of the tensile testing machine 1, which is measured by the first measurement unit 535, in a superimposing manner. The display control unit 537 displays a Bode diagram to display the response characteristic of the tensile testing machine 1.

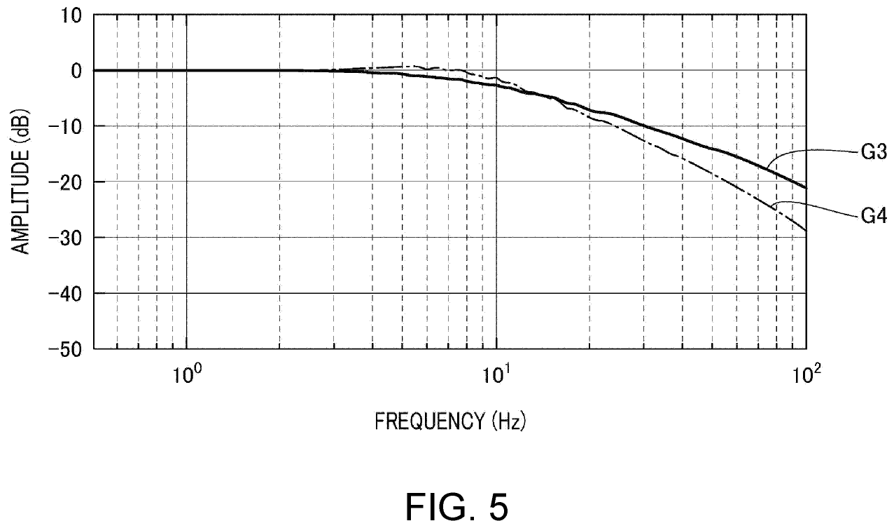

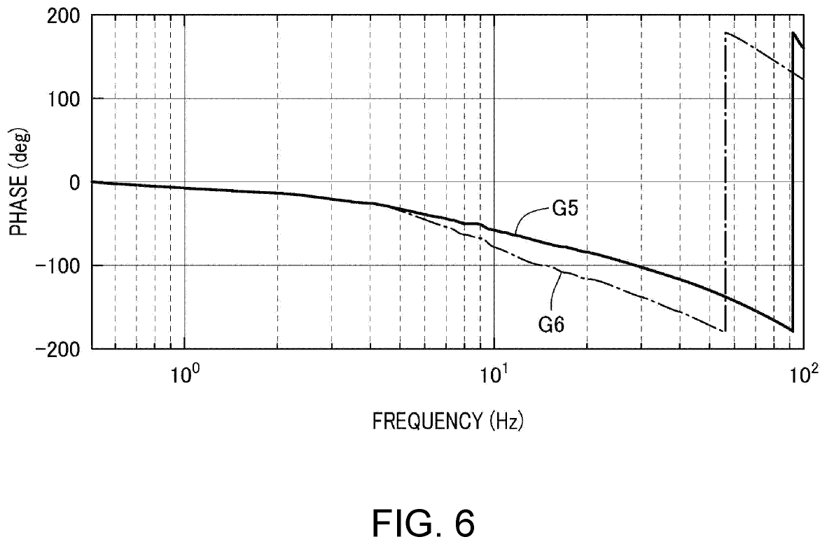

FIG. 5 is a diagram illustrating an example of a gain diagram displayed by the display control unit 537. FIG. 6 is a diagram illustrating an example of a phase diagram displayed by the display control unit 537.

A graph G3 and a graph G5 indicate the response characteristic of the tensile testing machine 1, which is measured by the first measurement unit 535. In the first set value set as the control parameter 543 at the time of measuring the response characteristic of the tensile testing machine 1, which is indicated by the graph G3 and the graph G5, the value of the proportional gain P is “203”, the value of the integration gain I is “0.031”, the value of the differential gain D is “0.00”, the value of the first coefficient b is “0.51”, and the value of the second coefficient c is “0.5”.

A graph G4 and a graph G6 are the response characteristic of the tensile testing machine 1, which is estimated by the estimation unit 534, and indicate the response characteristic of the tensile testing machine 1 in a state in which the second set value is set as the control parameter 543. In the second set value used for estimating the response characteristic indicated by the graph G4 and the graph G6, the value of the proportional gain P is “202”, the value of the integration gain I is “0.144”, the value of the differential gain D is “24.00”, the value of the first coefficient b is “0.91”, and the value of the second coefficient c is “0.5”.

As illustrated in FIGS. 5 and 6, the display control unit 537 displays the response characteristic of the tensile testing machine 1, which is estimated by the estimation unit 534, and the response characteristic of the tensile testing machine 1, which is measured by the first measurement unit 535, in a superimposing manner. Therefore, without performing a test for obtaining the response characteristic of the tensile testing machine 1 in a case where the set value of the control parameter 543 is changed, the user can confirm a difference between the response characteristic of the tensile testing machine 1 before the set value of the control parameter 543 is changed and the response characteristic of the tensile testing machine 1 in a case where the set value of the control parameter 543 is changed. Accordingly, in the adjustment of the control parameter 543, the user's labor can be reduced, and the user can easily determine an appropriate value of the control parameter 543.

In a case where the estimation unit 534 estimates the response characteristic of the tensile testing machine 1 a plurality of times, the display control unit 537 displays a plurality of the response characteristics of the tensile testing machine 1 in a superimposing manner. That is, in a case where the estimation unit 534 estimates the first response characteristic and the second response characteristic, the display control unit 537 displays the first response characteristic and the second response characteristic in a superimposing manner.

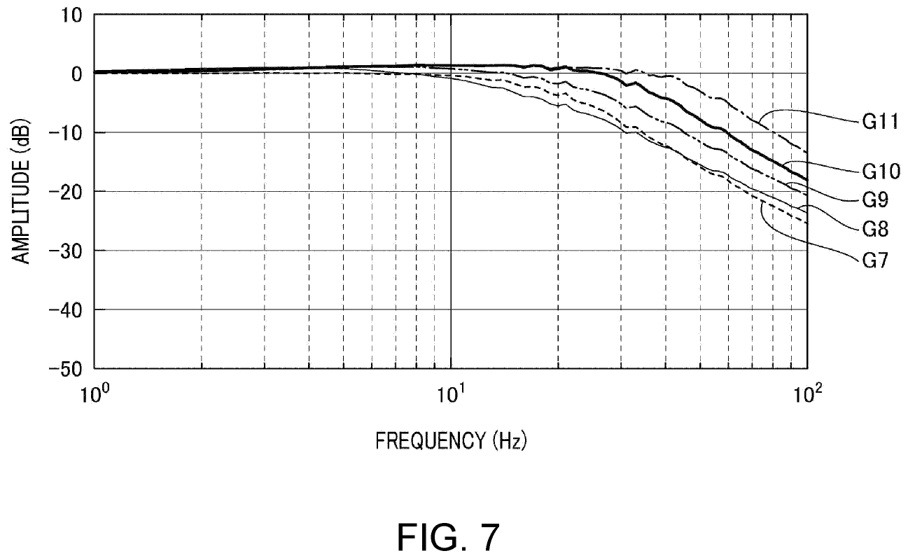

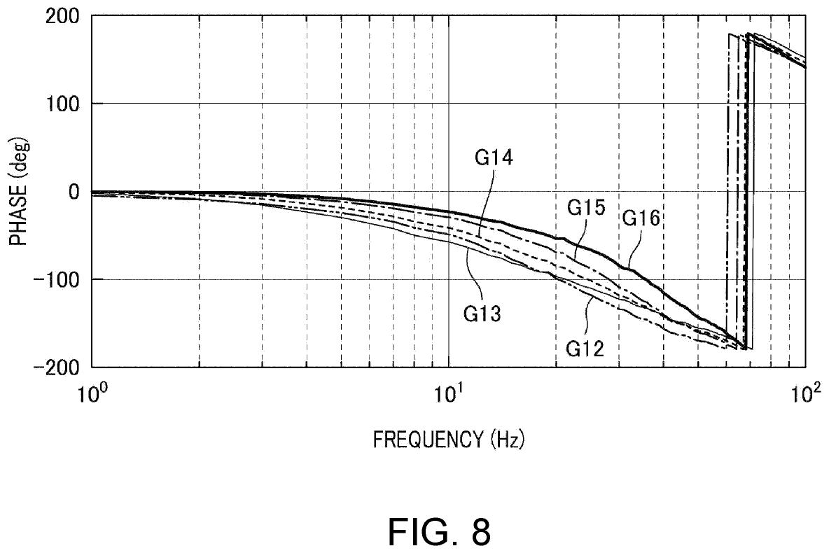

FIG. 7 is a diagram illustrating an example of a gain diagram displayed by the display control unit 537. FIG. 8 is a diagram illustrating an example of a phase diagram displayed by the display control unit 537.

Each of the response characteristic of the tensile testing machine 1, which is indicated by a graph G8 and a graph G13, the response characteristic of the tensile testing machine 1, which is indicated by a graph G9 and a graph G14, the response characteristic of the tensile testing machine 1, which is indicated by a graph G10 and a graph G15, and the response characteristic of the tensile testing machine 1, which is indicated by a graph G11 and a graph G16, corresponds to an example of the first response characteristic and the second response characteristic.

A graph G7 indicates a gain characteristic measured by the first measurement unit 535. when measuring the gain characteristic indicated by the graph G7, in the first set value set as the control parameter 543, the value of the proportional gain P is “168”, the value of the integration gain I is “5”, the value of the differential gain D is “40”, the value of the first coefficient b is “1”, and the value of the second coefficient c is “1”.

The graphs G8, G9, G10, and G11 indicate the gain characteristic estimated by the estimation unit 534. Each of the candidates of the set value used for estimating each of the gain characteristics indicated by the graphs G8, G9, G10, and G11 corresponds to an example of the second set value and the third set value.

In the candidate of the set value used for estimating the gain characteristic indicated by the graph G8, the value of the proportional gain P is “192”, the value of the integration gain I is “0.047”, the value of the differential gain D is “50”, the value of the first coefficient b is “1”, and the value of the second coefficient c is “1”.

In the candidate of the set value used for estimating the gain characteristic indicated by the graph G9, the value of the proportional gain P is “184”, the value of the integration gain I is “0.062”, the value of the differential gain D is “45”, the value of the first coefficient b is “1”, and the value of the second coefficient c is “1”.

In the candidate of the set value used for estimating the gain characteristic indicated by the graph G10, the value of the proportional gain P is “176”, the value of the integration gain I is “0.083”, the value of the differential gain D is “52”, the value of the first coefficient b is “1”, and the value of the second coefficient c is “1”.

In the candidate of the set value used for estimating the gain characteristic indicated by the graph G11, the value of the proportional gain P is “165”, the value of the integration gain I is “0.12”, the value of the differential gain D is “63”, the value of the first coefficient b is “1”, and the value of the second coefficient c is “1”.

In FIG. 8, a graph G12 indicates a phase characteristic measured by the first measurement unit 535. The first set value set as the control parameter 543 in the measurement of the phase characteristic indicated by the graph G12 is the same as the first set value set as the control parameter 543 in the measurement of the gain characteristic indicated by the graph G7.

In FIG. 8, the graphs G13, G14, G15, and G16 indicates the phase characteristic estimated by the estimation unit 534. A candidate of the set value used for estimating the phase characteristic indicated by the graph G13 is the same as the candidate of the set value used for estimating the gain characteristic indicated by the graph G8. A candidate of the set value used for estimating the phase characteristic indicated by the graph G14 is the same as the candidate of the set value used for estimating the gain characteristic indicated by the graph G9. A candidate of the set value used for estimating the phase characteristic indicated by the graph G15 is the same as the candidate of the set value used for estimating the gain characteristic indicated by the graph G10. A candidate of the set value used for estimating the phase characteristic indicated by the graph G16 is the same as the candidate of the set value used for estimating the gain characteristic indicated by the graph G11.

As illustrated in FIGS. 7 and 8, the display control unit 537 displays a plurality of the response characteristics of the tensile testing machines 1 in a superimposing manner. Therefore, without performing a test for obtaining the response characteristic of the tensile testing machine 1, the user can confirm how the response characteristic of the tensile testing machine 1 change when the set value of the control parameter 543 is changed. Accordingly, in the adjustment of the control parameter 543, the user's labor can be reduced, and the user can easily determine an appropriate value of the control parameter 543.

The display control unit 537 can display the response characteristic of the tensile testing machine 1, which is measured by the second measurement unit 536, and the response characteristic of the tensile testing machine 1, which is estimated by the estimation unit 534, in a superimposing manner.

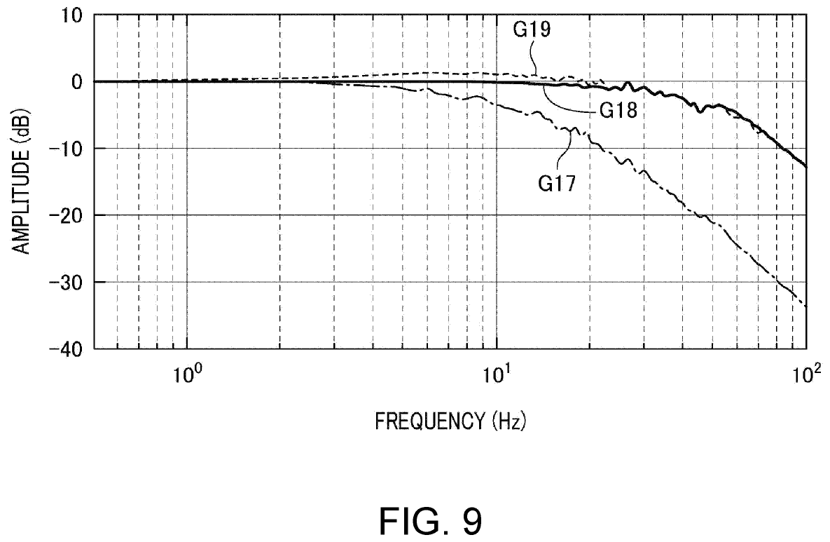

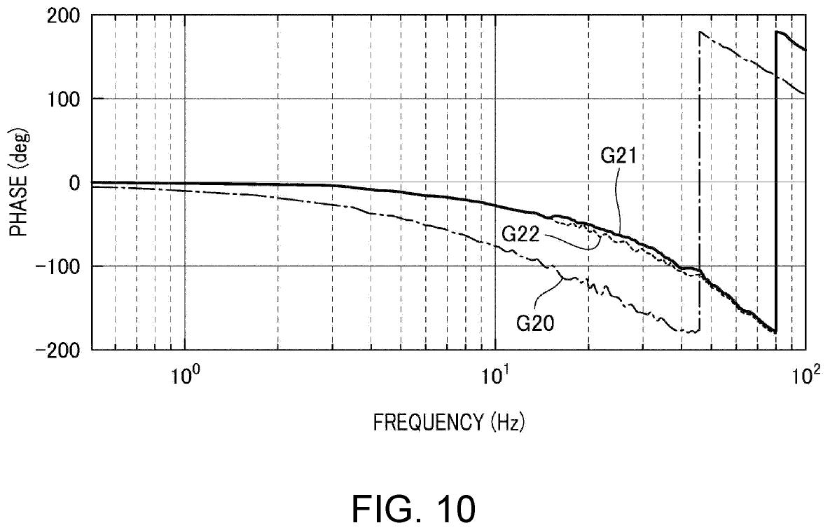

FIG. 9 is a diagram illustrating an example of a gain diagram displayed by the display control unit 537. FIG. 10 is a diagram illustrating an example of a phase diagram displayed by the display control unit 537.

A graph G17 and a graph G20 indicate the response characteristic of the tensile testing machine 1, which is measured by the first measurement unit 535. when measuring the response characteristic indicated by the graph G17 and the graph G20, in the first set value set as the control parameter 543, the value of the proportional gain P is “168”, the value of the integration gain I is “5”, the value of the differential gain D is “40”, the value of the first coefficient b is “1”, and the value of the second coefficient c is “1”.

A graph G18 and a graph G21 are the response characteristic of the tensile testing machine 1, which is estimated by the estimation unit 534, and indicate the response characteristic of the tensile testing machine 1 in a state in which the second set value is set as the control parameter 543. In the second set value substituted into Equation (1) when estimating the response characteristic of the tensile testing machine 1, which is indicated by the graph G18 and the graph G21, the value of the proportional gain P is “192”, the value of the integration gain I is “0.047”, the value of the differential gain D is “50”, the value of the first coefficient b is “1”, and the value of the second coefficient c is “1”.

A graph G19 and a graph G22 indicate the response characteristic of the tensile testing machine 1, which is measured by the second measurement unit 536. when measuring the response characteristic indicated by the graph G19 and the graph G22, in the second set value set as the control parameter 543, the value of the proportional gain P is “192”, the value of the integration gain I is “0.047”, the value of the differential gain D is “50”, the value of the first coefficient b is “1”, and the value of the second coefficient c is “1”.

As illustrated in FIGS. 9 and 10, the display control unit 537 displays the response characteristic of the tensile testing machine 1, which is estimated by the estimation unit 534, and the response characteristic of the tensile testing machine 1, which is measured by the second measurement unit 536, in a superimposing manner. Therefore, the user can easily confirm the accuracy of the estimated response characteristic of the tensile testing machine 1.

### 4. PROCESSING OF CONTROL UNIT

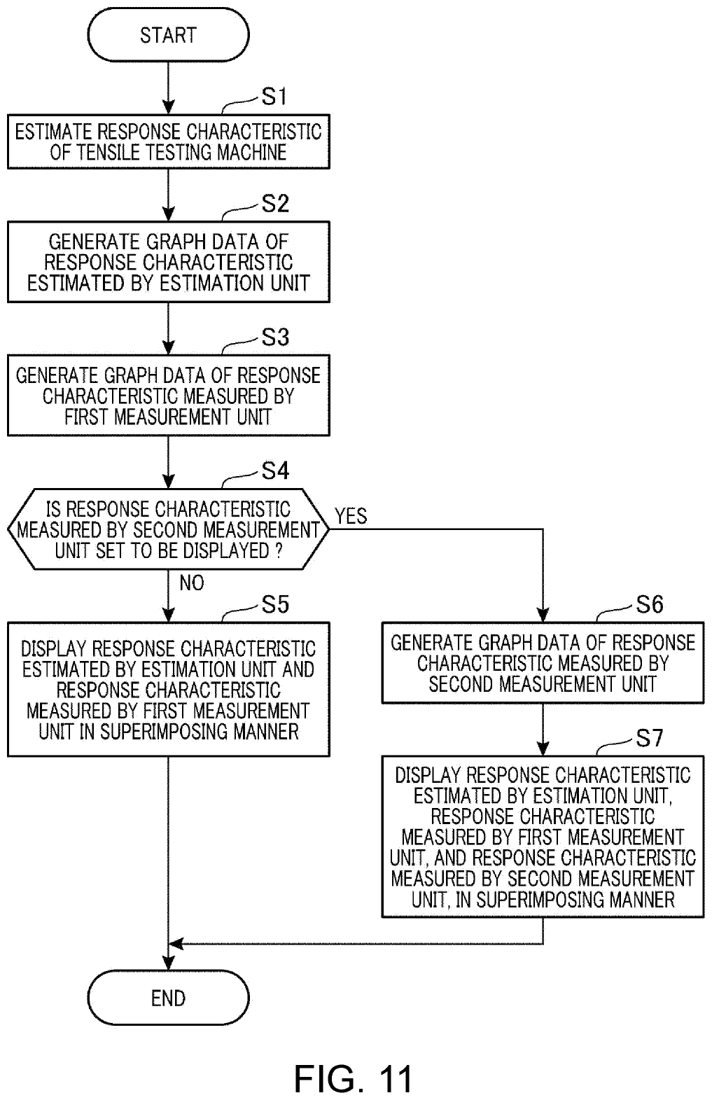

FIG. 11 is a flowchart illustrating an example of processing of the control unit 52.

Next, in Step S1, the estimation unit 534 estimates the response characteristic of the tensile testing machine 1. In a case where the reception unit 533 receives a plurality of candidates, the estimation unit 534 estimates a plurality of the response characteristics of the tensile testing machine 1.

Next, in Step S2, the display control unit 537 generates graph data indicating the response characteristic of the tensile testing machine 1, which is estimated by the estimation unit 534.

Next, in Step S3, the display control unit 537 generates graph data indicating the response characteristic of the tensile testing machine 1, which is measured by the first measurement unit 535.

Next, in Step S4, the display control unit 537 determines whether or not the response characteristic of the tensile testing machine 1, which is measured by the second measurement unit 536, is set to be displayed.

In a case where it is determined that the response characteristic of the tensile testing machine 1, which is measured by the second measurement unit 536, is not set to be displayed (Step S4: NO), in Step S5, the display control unit 537 displays the response characteristic of the tensile testing machine 1, which is estimated by the estimation unit 534, and the response characteristic of the tensile testing machine 1, which is measured by the first measurement unit 535, in an superimposing manner.

In a case where it is determined that the response characteristic of the tensile testing machine 1, which is measured by the second measurement unit 536, is set to be displayed (Step S4: YES), in Step S6, the display control unit 537 generates graph data indicating the response characteristic of the tensile testing machine 1, which is measured by the second measurement unit 536.

Next, in Step S7, the display control unit 537 displays the response characteristic of the tensile testing machine 1, which is estimated by the estimation unit 534, the response characteristic of the tensile testing machine 1, which is measured by the first measurement unit 535, and the response characteristic of the tensile testing machine 1, which is measured by the second measurement unit 536, in a superimposing manner.

As described above, the display control unit 537 displays the response characteristic of the tensile testing machine 1, which is estimated by the estimation unit 534, and the response characteristic of the tensile testing machine 1, which is measured by the first measurement unit 535, in a superimposing manner. However, the display control unit 537 may display only the response characteristic of the tensile testing machine 1, which is estimated by the estimation unit 534.

### 5. EMBODIMENTS AND EFFECTS

It will be understood by those skilled in the art that the above-described embodiments and modification examples are specific examples of the following aspects.

(Item 1)

According to the present embodiment, there is provided a material testing machine that includes a testing machine main body having an actuator, the material testing machine including an estimation unit that estimates a response characteristic of the material testing machine, in which the estimation unit obtains the response characteristic of the testing machine main body in a state in which a first set value used for a material test performed by the material testing machine is set as a control parameter specifying operation of the actuator, and estimates, based on the obtained response characteristic of the testing machine main body, the response characteristic of the material testing machine in a state in which a second set value different from the first set value is set as the control parameter.

In the material testing machine according to Item 1, it is possible to obtain the response characteristic of the material testing machine in a case where the value of the control parameter is changed, and thus the operator can adjust the control parameter without performing a test for obtaining the response characteristic of the material testing machine. Therefore, it is possible to reduce the labor of the operator in adjusting the control parameter.

(Item 2)

In the material testing machine according to Item 1, a display control unit that displays the response characteristic of the material testing machine, which is estimated by the estimation unit, is provided.

In the material testing machine according to item 2, the operator can confirm the response characteristic of the material testing machine in a case where the value of the control parameter is changed, and thus the operator can adjust the control parameter without performing a test for obtaining the response characteristic of the material testing machine. Therefore, it is possible to reduce the labor of the operator in adjusting the control parameter.

(Item 3)

In the material testing machine according to Item 2, the estimation unit estimates a first response characteristic that is the response characteristic of the material testing machine in a state in which the second set value is set as the control parameter and a second response characteristic that is the response characteristic of the material testing machine in a state in which a third set value different from the second set value is set as the control parameter, and the display control unit displays the first response characteristic estimated by the estimation unit and the second response characteristic estimated by the estimation unit in a superimposing manner.

In the material testing machine according to Item 3, without performing a test for obtaining the response characteristic of the tensile testing machine, the operator can confirm how the response characteristic of the material testing machine changes when the set value of the control parameter is changed. Therefore, in the adjustment of the control parameter, the operator's labor can be reduced, and the operator can easily determine an appropriate value of the control parameter.

(Item 4)

In the material testing machine according to Item 2 or 3, a first measurement unit that measures the response characteristic of the material testing machine in a state in which the first set value is set as the control parameter is provided, and the display control unit displays the response characteristic of the material testing machine, which is estimated by the estimation unit, and the response characteristic of the material testing machine, which is measured by the first measurement unit, in a superimposing manner.

In the material testing machine according to Item 4, Therefore, without performing a test for obtaining the response characteristic of the material testing machine in a case where the set value of the control parameter is changed, the operator can confirm a difference between the response characteristic of the material testing machine before the set value of the control parameter is changed and the response characteristic of the material testing machine in a case where the set value of the control parameter is changed. Therefore, in the adjustment of the control parameter, the operator's labor can be reduced, and the operator can easily determine an appropriate value of the control parameter.

(Item 5)

In the material testing machine according to any one of Items 2 to 4, a second measurement unit that measures the response characteristic of the material testing machine in a state in which the second set value is set as the control parameter is provided, and the display control unit displays the response characteristic of the material testing machine, which is estimated by the estimation unit, and the response characteristic of the material testing machine, which is measured by the second measurement unit, in a superimposing manner.

In the material testing machine according to Item 5, the operator can compare the estimated response characteristic of the material testing machine with the response characteristic of the material testing machine, and thus the operator can easily confirm the accuracy of the estimated response characteristic of the material testing machine.

### 6. ANOTHER EMBODIMENT

The tensile testing machine 1 according to the present embodiment is merely an example of an aspect of the material testing machine according to the present disclosure, and can be arbitrarily modified and applied without departing from the gist of the present disclosure.

For example, in the embodiment described above, a case in which the material testing machine is the tensile testing machine 1 is described, but the present embodiment is not limited to this. The material testing machine is only required to apply the testing force to the specimen SP, and deform the specimen SP to perform the material test. For example, the material testing machine may be a compression tester, a bending tester, or a torsion tester.

Each functional unit illustrated in FIGS. 1 and 2 indicates a functional configuration, and a specific mounting form is not particularly limited. That is, hardware corresponding to each functional unit is not necessarily needed to be mounted, and functions of a plurality of the functional units can also be implemented by one processor executing a program. In the above-described embodiment, a part of the functions implemented by software may be implemented by hardware, or a part of the functions implemented by the hardware may be implemented by the software.

The processing units of the flowchart illustrated in FIG. 11 is divided depending on a main processing content for easy understanding of the processing of the control unit 52. Dividing the processing units is not limited by a dividing method and names of the processing units indicated in the flowchart of FIG. 11, and the processing units can be divided into more processing units depending on the processing content, and one processing unit also can be divided to include more processing units. The processing order of the above-described flowcharts is not limited to the illustrated example.

The control device 50 of the tensile testing machine 1 can execute the control program 541 corresponding to the display method in the tensile testing machine 1 on the processor 53 included in the control unit 52. The control program 541 can also be recorded on the recording medium that can be read by the computer. As the recording medium, a magnetic or optical recording medium or a semiconductor memory device can be used. Specifically, a portable recording medium such as a flexible disk, an HDD, a compact disk read only memory (CD-ROM), a DVD, a Blu-ray (registered trademark) disc, a magneto-optical disk, a flash memory, and a card-type recording medium, or a fixed recording medium is exemplified. The recording medium may be a non-volatile storage device such as a RAM, a ROM, and an HDD, which is an internal storage device included in the control unit 52. The control program 541 may be stored in a server apparatus or the like, and the control program 541 may be downloaded from the server apparatus to the control unit 52.

What is claimed is:

1. A material testing machine that includes a testing machine main body having an actuator, the material testing machine comprising
an estimation unit that estimates a response characteristic of the material testing machine,
wherein the estimation unit
obtains the response characteristic of the testing machine main body in a state in which a first set value used for a material test performed by the material testing machine is set as a control parameter specifying operation of the actuator, and
estimates, based on the obtained response characteristic of the testing machine main body, the response characteristic of the material testing machine in a state in which a second set value different from the first set value is set as the control parameter.

2. The material testing machine according to claim 1, comprising
a display control unit that displays the response characteristic of the material testing machine, which is estimated by the estimation unit.

3. The material testing machine according to claim 2,
wherein the estimation unit estimates a first response characteristic that is the response characteristic of the material testing machine in a state in which the second set value is set as the control parameter and a second response characteristic that is the response characteristic of the material testing machine in a state in which a third set value different from the second set value is set as the control parameter, and
the display control unit displays the first response characteristic estimated by the estimation unit and the second response characteristic estimated by the estimation unit in a superimposing manner.

4. The material testing machine according to claim 2 or 3, comprising
a first measurement unit that measures the response characteristic of the material testing machine in a state in which the first set value is set as the control parameter,
wherein the display control unit displays the response characteristic of the material testing machine, which is estimated by the estimation unit, and the response characteristic of the material testing machine, which is measured by the first measurement unit, in a superimposing manner.

5. The material testing machine according to claim 2, comprising
a second measurement unit that measures the response characteristic of the material testing machine in a state in which the second set value is set as the control parameter,
wherein the display control unit displays the response characteristic of the material testing machine, which is estimated by the estimation unit, and the response characteristic of the material testing machine, which is measured by the second measurement unit, in a superimposing manner.
